(19) United States
(12) Patent Application Publication
(10) Pub. No.: US 2015/0070592 A1
(43) Pub. Date: Mar. 12, 2015

(54) LIQUID CRYSTAL DISPLAY APPARATUS AND TELEVISION RECEIVER

(71) Applicant: SHARP KABUSHIKI KAISHA, Osaka-shi, Osaka (JP)

(72) Inventor: Masaaki Ishiguro, Osaka-shi (JP)

(73) Assignee: SHARP KABUSHIKI KAISHA, Osaka-shi, Osaka (JP)

(21) Appl. No.: 14/391,958

(22) PCT Filed: Mar. 29, 2013
(86) PCT No.: PCT/JP2013/059434

§ 371 Date: Oct. 10, 2014

(30) Foreign Application Priority Data
Apr. 13, 2012 (JP) 2012-092237

(51) Int. Cl. F21V 8/00; G02F 1/1335

(52) U.S. Cl. CPC G02B 6/0083; G02F 1/1336; G02B 6/0093
USPC 348/794; 349/65

(57) ABSTRACT

A housing of a backlight unit is reinforced by a reinforcement frame installed so as to communicate an upper edge and a lower edge of the back face, and a window hole is formed at an upper edge of the housing at the vicinity of the reinforcement frame. An LED substrate as a light source is accommodated inside the housing and connected to a harness through the window hole. A harness is wired inside the reinforcement frame, and the harness is connected to a substrate such as a main substrate and a power supply substrate installed on the back face of the housing. It is possible to prevent exposure of the harness at the back face of the housing with a minimum use of a harness cover and to prevent generation of malfunction such as damage to the harness and disconnection.

### CROSS-REFERENCE TO RELATED APPLICATIONS

This application is the national phase under 35 U.S.C. §371 of PCT International Application No. PCT/JP2013/059434 which has an International filing date of Mar. 29, 2013 and designated the United States of America.

### FIELD

The present invention relates to a liquid crystal display apparatus including a liquid crystal panel as an image display part and to a television receiver.

### BACKGROUND

A liquid crystal display apparatus is configured to arrange a backlight at the back of a liquid crystal panel, modulate light emission from the backlight through the liquid crystal panel and transmit it, and display images at the front of the liquid crystal panel. With regard to the liquid crystal display apparatus, edge-light type backlights with LEDs (light emitting diodes) as a light source have been used to achieve a reduction in power consumption and miniaturization in recent years (for example, see Brochure of International Publication WO 2008/108039).

An edge-light type backlight includes a light guide plate disposed opposite to the back face of the liquid crystal panel and a plurality of LEDs aligned along one side edge of the light guide plate, and is configured so as to accommodate the light guide plate and the plurality of LEDs inside a rectangular dish-shaped housing (backlight chassis). The plurality of LEDs are aligned in a single row or multiple rows and mounted on a long strip-like LED substrate, and a mounting surface is attached oppositely to one side edge of the light guide plate.

Each of the LEDs is connected to a main substrate and a power supply substrate through a connector provided at one part of the LED substrate, and emits light in response to an operation of a control circuit formed on the main substrate realized by power feeding from the power supply substrate. The emitted light is incident into the light guide plate from one side edge and is to be emitted from the entire surface opposed to the liquid crystal panel.

### SUMMARY

In a liquid crystal display apparatus disclosed in Brochure of International Publication WO 2008/108039, a window hole is opened at the position of a connector provided on an internal LED substrate at a backlight chassis, and the LED substrate is connected to a main substrate and a power supply substrate by a harness connected to a connector through the window hole. The harness is drawn around on the back face of the backlight and then is clasped at an intermediate portion by a proper clasp to achieve wire processing.

A general liquid crystal display apparatus is configured to incorporate a front cabinet with a rectangular shape to surround a display region of an image at the front side of a liquid crystal panel, and to incorporate a back cabinet at the back side of the front cabinet. The back cabinet is provided to cover the entire back face of the backlight chassis to protect installation components at the back face such as the above-described main substrate, power supply substrate and harness.

On the other hand, along with enlargement of the liquid crystal display apparatus in recent years, attempts have been made to locally cover only the installation parts such as the above-described main substrate and power supply substrate with a cover and omit a back cabinet with a large area for covering the entire back face. However, in this configuration, since a harness drawn around on the back face of the backlight chassis described above is in the state of being exposed, the harness may be damaged or disconnected due to inevitable contact in an operating state and hence there is a problem to cause malfunction of the crystal liquid display apparatus including a backlight.

This problem may be solved by means of covering an exposed part of a harness with a dedicated cover similar to the main substrate, the power supply substrate or the like, however, the arrangements for a harness are variously different so that it is difficult to provide a cover capable of handling all arrangements. Even if it is possible, it is inevitable to increase the number of parts and hence the cost for manufacturing a liquid crystal display apparatus is increased.

In view of such circumstances related to the present invention, with regard to the configuration in which a back cabinet covering the whole back face of the backlight chassis is omitted, the present invention aims to provide a liquid crystal display apparatus and a television receiver capable of firmly covering a harness arranged at the back face of the backlight chassis to prevent generation of malfunction such as damage or disconnection.

There is provided a liquid crystal display apparatus in which a backlight unit where a light guide plate and a plurality of solid light-emitting elements opposite to one side edge of the light guide plate are accommodated in a housing is attached so as to be opposite to the back face of a liquid crystal panel, and in which an element substrate mounted with the solid light-emitting elements and a substrate attached to the back face of the housing are connected by a harness connected to the element substrate through a window hole opened to the position of the housing and wired along the back face of the housing, wherein the window hole is formed at the vicinity of a reinforcement frame installed at the back face of the housing, and the harness is wired through the inside of the reinforcement frame; and a harness cover covers between an opening position of the window hole and the reinforcement frame.

In the present invention, the reinforcement frame installed at the back face of the housing for reinforcing the backlight unit is used, the harness connected to the element substrate through the window hole provided at the vicinity of the reinforcement frame is guided to an attachment position of the substrate through the inside of the reinforcement frame, and the harness is pulled out from the position and connected to the substrate; and the harness cover covers only an exposed part of the harness between the window hole and the reinforcement frame. The size and shape of the harness cover is determined by only the positional relation between the window hole and the reinforcement frame, therefore, it is possible to use a harness cover universal to many models.

In the liquid crystal display apparatus according to the present invention, the window hole is opened including a part inside the reinforcement frame.

In the present invention, a part of the window hole is located inside the reinforcement frame, and the cover harness covering between an opening position of the window hole and the reinforcement frame can be miniaturized.

There is provided a liquid crystal display apparatus in which a backlight unit where a light guide plate and a plurality of solid light-emitting elements opposite to one side edge of the light guide plate are accommodated in a housing is attached so as to be opposite to the back face of a liquid crystal panel, and in which an element substrate mounted with the solid light-emitting elements and a substrate attached to the back face of the housing are connected by a harness connected to the element substrate through a window hole opened to the position of the housing and wired along the back face of the housing, wherein the window hole is formed inside a reinforcement frame installed at the back face of the housing, and the harness is wired through the inside of the reinforcement frame.

In the present invention, the window hole for connecting the harness to the element substrate inside the housing is opened to the inside of the reinforcement frame installed at the back face of the housing, and the harness connected to the element substrate through the window hole is directly introduced into the reinforcement frame and guided to an arrangement position of the substrate through the inside of the reinforcement frame and then is connected to the substrate. Accordingly, it is possible to omit a harness cover.

In the liquid crystal display apparatus according to the present invention, the reinforcement frame has a gate-shaped cross section and is attached such that leg parts on both sides are in contact with the back face of the housing.

In the present invention, the reinforcement frame having a gate-shaped cross section is attached with leg parts on both sides being in contact with the back face of the housing, and an installation space for the harness is ensured sufficiently between the reinforcement frame and the back face of the housing.

A television receiver according to the present invention is provided with the liquid crystal display apparatus described in any one described above and a receiving part which receives television broadcasts, and it is configured to display an image in the liquid crystal display apparatus based on the television broadcasts received by the receiving part.

The present invention provides a television receiver with a simple configuration in which a back cabinet is omitted.

The present invention utilizes the inside of a reinforcement frame installed at the back face of a housing of a backlight unit as a wiring space for a harness connected to an element substrate in the housing and a substrate attached to the back face of the housing, therefore, it is possible to realize the configuration in which a back cabinet is omitted without generating malfunction such as damage to a harness or disconnection. Accordingly, the present invention generates excellent effects.

The above and further objects and features will more fully be apparent from the following detailed description with accompanying drawings.

### BRIEF DESCRIPTION OF THE DRAWINGS

FIG. 1 is an exploded perspective view that briefly shows a liquid crystal display apparatus according to Embodiment 1.

FIG. 2 is a perspective view of an LED substrate.

FIG. 3 is an enlarged cross-sectional view of a fixing part of the LED substrate.

FIG. 4 is a plan view of the liquid crystal display apparatus as seen from the back side of a backlight chassis.

FIG. 5 is a plan view of the liquid crystal display apparatus as seen from the back side of the backlight chassis.

FIG. 6 is a plan view that shows the enlargement of a connection part of a harness.

FIG. 7 is a cross-sectional view of a reinforcement frame taken along the line VII-VII of FIG. 4.

FIG. 8 is a back view of a liquid crystal display apparatus according to Embodiment 2.

FIG. 9 is a plan view that shows the enlargement of a connection part of a harness according to Embodiment 2.

FIG. 10 is a back view of a liquid crystal display apparatus according to Embodiment 3.

FIG. 11 is a plan view that shows the enlargement of a connection part of a harness according to Embodiment 3.

### DETAILED DESCRIPTION

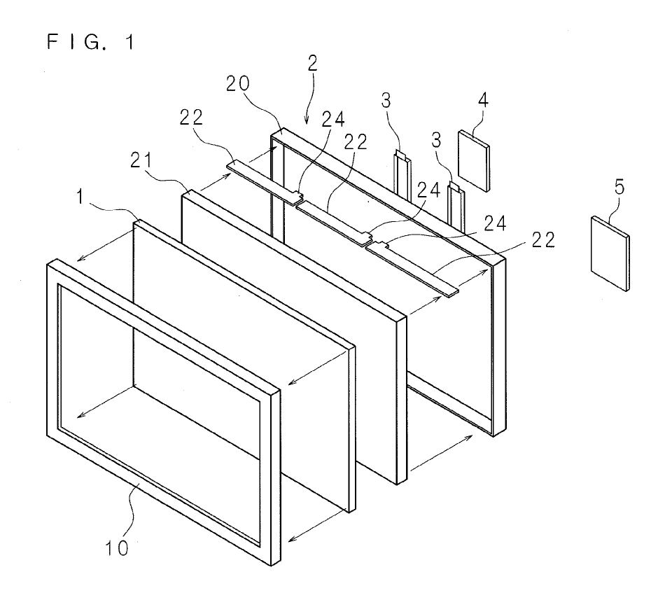

The present invention is described below in detail with reference to the drawings showing the embodiments. FIG. 1 is an exploded perspective view that briefly shows a liquid crystal display apparatus according to Embodiment 1. The liquid crystal display apparatus as shown in the figure includes a liquid crystal panel 1 for displaying images and a backlight unit 2 for irradiating light on the back side of the liquid crystal panel 1.

The liquid crystal panel 1 has a well-known configuration in which liquid crystal is enclosed between an array substrate and a color filter substrate; an optical sheet such as a visual field expansion sheet or an anti-reflection sheet is adhered to one surface; and a polarized plate is laminated on both surfaces. In FIG. 1, the liquid crystal panel 1 as described above is briefly shown as a rectangular dish-shaped panel, and a front cabinet 10 with a rectangular frame shape is assembled so as to fringe a peripheral portion over a proper width at the front side (image display surface) of the liquid crystal panel 1.

The backlight unit 2 includes a backlight chassis 20, a light guide plate 21, and an LED substrate 22. The backlight chassis 20 is a rectangular housing formed into a shallow-bottom dish shape. The light guide plate 21 is an optical member respectively providing a reflection part on one surface of a flat plate made of resin having translucency such as acrylic resin, and a diffusion part on the other surface. The light guide plate 21 is formed into a rectangular shape nearly the same dimension of the liquid crystal panel 1. The light guide plate 21 has a surface formed with the reflection part opposite to the bottom surface of the backlight chassis 20. The light guide plate 21 is accommodated into the backlight chassis 20 so as to cover the substantially entire part of the bottom surface.

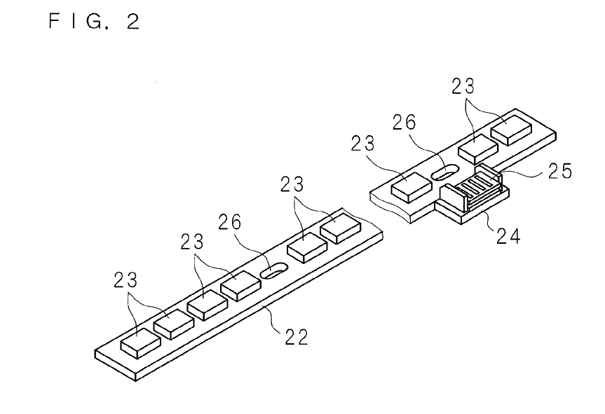

FIG. 2 is a perspective view of an LED substrate 22. The LED substrate 22 as shown in the figure is formed into a long-strip shape. A plurality of LEDs 23, 23 . . . are mounted in a single row at equal intervals on one surface of the LED substrate 22. The LED 23 is, for example, a surface mounting type LED sealing the surface of an LED element emitting blue light with resin in which a yellow phosphor is dispersed, and it is configured as a light source emitting white light. The LED 23 may also be an LED in a form other than a surface mounting type. Another solid light-emitting element such as an organic EL element can also be used in place of the LED 23.

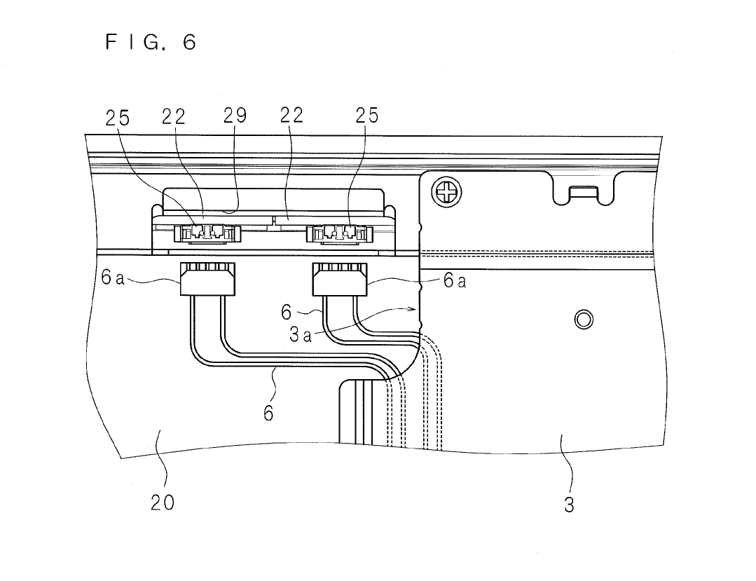

The LED substrate 22 includes a projection part 24 projected outwardly in a width direction at the vicinity of the end portion in a longitudinal direction. The projection part 24 is provided with a connector 25. The connector 25 is used for the connection of a harness 6 (see FIG. 6) containing a power line and a signal line. Fixing holes 26 are formed on the LED substrate 22. The fixing holes 26 are formed through the LED substrate 22 back and forth. The fixing holes 26 are penetrating holes to be used for passing fixing screws of the LED substrate 22, locate between adjacent LEDs 23, 23, and are provided at a plurality of locations in a longitudinal direction of the LED substrate 22.

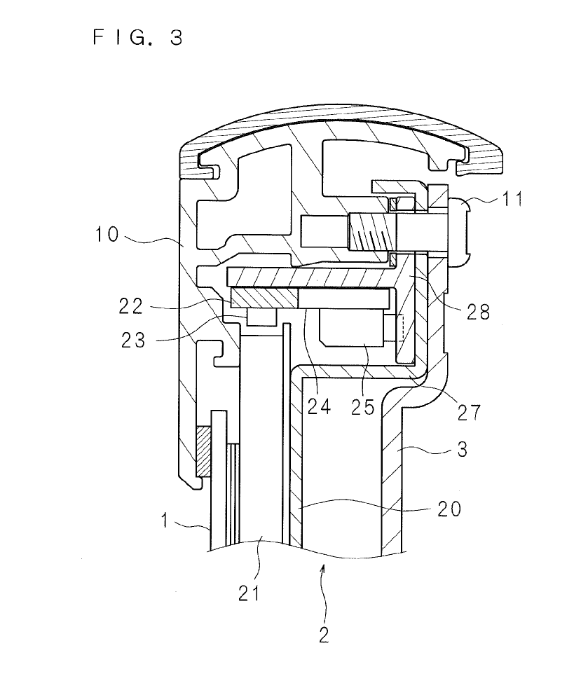

The three LED substrates 22 configured as described above are placed side by side in a longitudinal direction arranged along one long side edge of the light guide plate 21. FIG. 3 is an enlarged cross-sectional view of a fixing part of the LED substrate 22.

At the peripheral portion of the backlight chassis 20 as shown in the figure, a fixing flange 27, which rises substantially perpendicular to the back face of the backlight chassis 20 and extends outwardly by bending the tip portion, is provided. The backlight chassis 20 is fixed to the front cabinet 10 by stacking the fixing flange 27 on the front cabinet 10 from the back side thereof and fastening a plurality of locations through the fixing screws 11.

At the edge of the backlight chassis 20, a heat sink 28 is sandwiched between the fixing flange 27 and the front cabinet 10. In FIG. 3, a reinforcement frame 3 installed at the back face of the backlight chassis 20 is also shown. The end portion of the reinforcement frame 3 is stacked on the back side of the fixing flange 27, and the reinforcement frame 3 is fastened and fixed together with the backlight chassis 20 and the heat sink 28 by the fixing screw 11.

The heat sink 28 is bent substantially perpendicular from a sandwiched part formed of the fixing flange 27 and the front cabinet 10, and it has a fixing part opposite to the side edge of the light guide plate 21. The LED substrate 22 having the mounting surface of the LEDs 23, 23 . . . facing to the side of the light guide plate 21 is fixed to the fixing part. The fixing is achieved by fastening and fixing a fixing screw (not shown) passing through the fixing hole 26 to a screw hole provided at the position of the heat sink 28.

The heat sink 28 is a plate made of metal having excellent thermal conductivity such as aluminum, and it functions so as to transfer heat generated at the time of operations of the LEDs 23, 23 . . . to the fixing flange 27 and then emit heat to outside from the entire surface of the backlight chassis 20 including the fixing flange 27. The fixing hole 26 as shown in FIG. 2 is configured as an oblong hole extended in a longitudinal direction of the LED substrate 22, and the difference in expanding length between the LED substrate 22 and the heat sink 28 due to heat generation of the LEDs 23, 23 . . . is configured to be absorbable.

The backlight unit 2 configured as described above is aligned such that the light guide plate 21 accommodated in the backlight chassis 20 is opposite to the liquid crystal panel 1 as shown in FIG. 1. As described above, the backlight unit 2 is attached to the front cabinet 10 and the liquid crystal panel 1 to constitute a liquid crystal display apparatus by fixing the backlight chassis 20 to the front cabinet 10.

In the liquid crystal display apparatus configured as described above, the light emitted from the LED 23 mounted on the LED substrate 22 is incident into the light guide plate 21 opposed to the LED 23 from the side edge, and the light is repeatedly reflected inside the light guide plate 21 and propagated, and then the light is emitted from the entire surface opposed to the liquid crystal panel 1 provided with the diffusion part and irradiated on the back face of the liquid crystal panel 1. The liquid crystal panel 1 modulates light emitted from the backlight unit 2 that is irradiated on the back side and passes through the front side, and displays an image at the front.

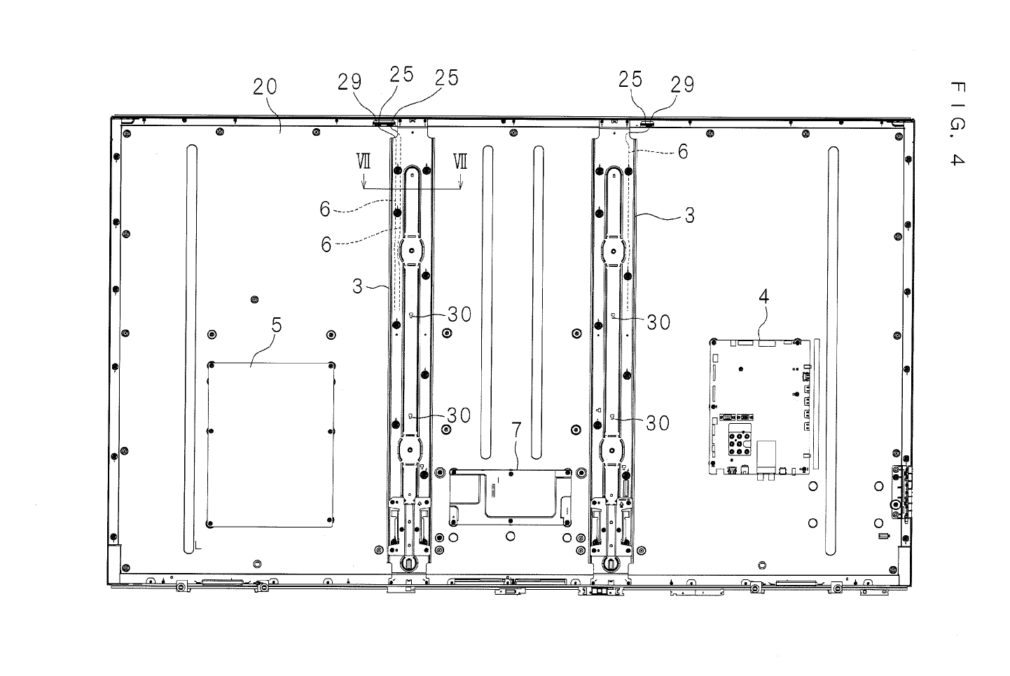

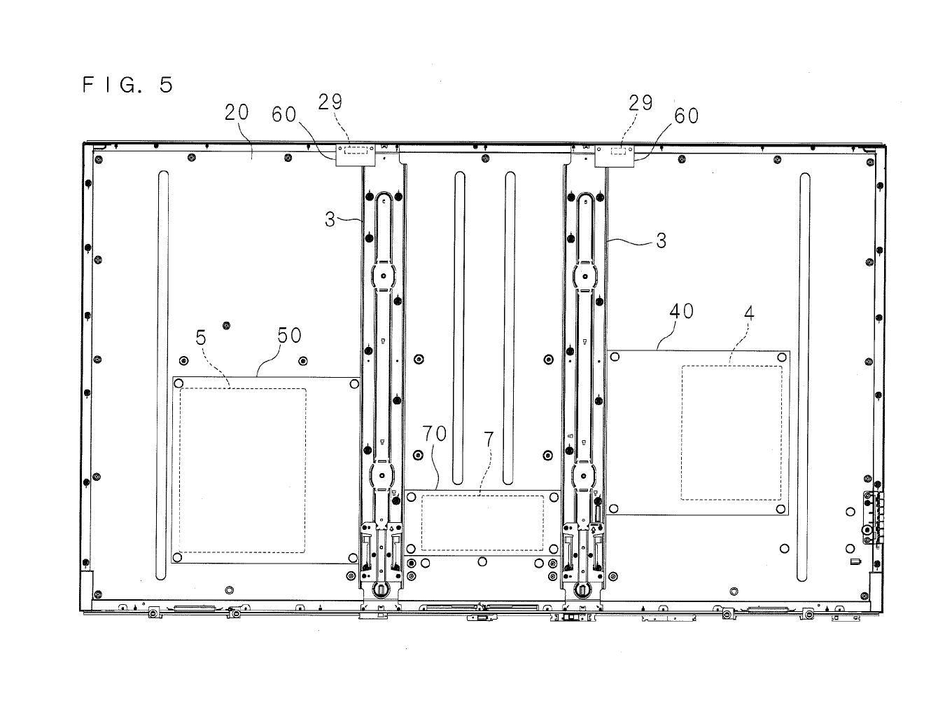

FIGS. 4 and 5 are plan views of the liquid crystal display apparatus as seen from the back side of the backlight chassis 20. FIG. 4 shows a state before the after-described substrate cover and harness cover are attached, and FIG. 5 shows a state after the substrate cover and harness cover are attached. The vertical direction in the figure corresponds to the upper/lower relationship when the liquid crystal display apparatus is in use. With regard to the following description, upper/lower and left/right in FIGS. 4 and 5 are used.

The LED substrate 22 in the backlight chassis 20 is arranged along the upper edge of the backlight chassis 20. The two reinforcement frames 3, 3 are attached to the back of the backlight chassis 20. These reinforcement frames 3, 3 are disposed separately on both left and right sides of the central portion of the backlight chassis 20 in a longitudinal direction, and they are installed between the upper edge and the lower edge. The reinforcement frames 3, 3 installed as described above press the backlight chassis 20 from the back side to prevent deformation of the backlight chassis 20.

On each of the reinforcement frames 3, 3, locking holes 30, 30 are provided at two locations aligning a vertical position at the central portion in a width direction. These locking holes 30, 30 are used for latching a supporting tool (not shown) provided on a wall surface when a liquid crystal display apparatus is mounted on a wall.

On the lower back face of the backlight chassis 20, a main substrate 4 and a power supply substrate 5 are attached at both left and right sides of the reinforcement frames 3, 3. On the other hand, at the upper side edge of the backlight chassis 20, window holes 29, 29 are opened at both left and right sides of the upper edge portions of the reinforcement frames 3, 3.

The opening positions of the window holes 29, 29 correspond to the positions of the connectors 25 of the LED substrate 22 fixed as described above in the backlight chassis 20. The window holes 29, 29 are provided for connecting one end of the harness 6 to the connector 25 exposed from each of the window holes 29, 29.

FIG. 6 is a plan view that shows the enlargement of a connection part of a harness. The window hole 29 provided at the backlight chassis 20 as shown in the figure is positioned at the vicinity of the installation position of the reinforcement frame 3. The connector 25 of the LED substrate 22 fixed along the upper edge at the inner side of the backlight chassis 20 as described above is exposed to the outside from the window hole 29. The window hole 29 shown in FIG. 6 is the window hole 29 disposed at the left side in FIGS. 4 and 5. The connectors 25, 25 provided at the abutted end portions of the two LED substrates 22, 22 are exposed from the window hole 29.

At one end portion of the harness 6, a connection part 6a connectable to the connector 25 is provided. The harness 6 is connected to the LED substrate 22 by plugging the connection part 6a to the corresponding connector 25. FIG. 6 shows a state before connection, and the connection part of the harness 6 is connected by plugging toward the back side from the front side of the paper to the connector 25 exposed from the window hole 29.

The harness 6 connected to the connector 25 as described above is introduced through an introduction port 3a opened at the same side to the inside of the reinforcement frame 3 near the window hole 29, and guided downward through the inner side of the reinforcement frame 3 as shown by a broken line in FIG. 4, and then pulled out from the lower portion of the reinforcement frame 3 to be connected to the main substrate 4 and the power supply substrate 5.

The two connectors 25, 25 are exposed from the left-side window hole 29 as shown in FIG. 6, and the two harnesses 6, 6 connected respectively to the connectors 25, 25 as shown in FIG. 4 are passed through the inside of the left-side reinforcement frame 3. On the other hand, from the right-side window hole 29, only one connector 25 is exposed, and one harness 6 is passed, as shown in FIG. 4, through the inside of the right-side reinforcement frame 3.

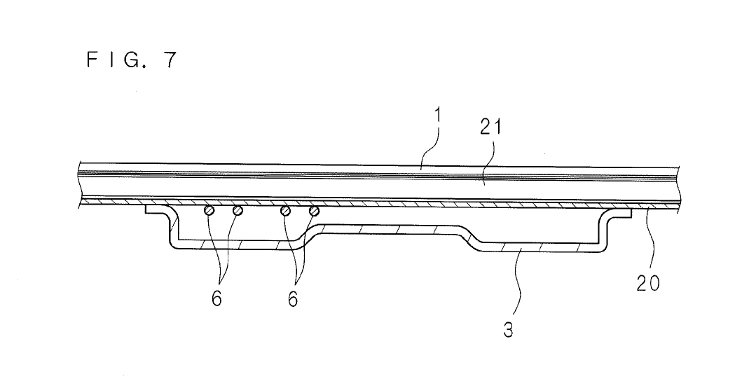

FIG. 7 is a cross-sectional view of the reinforcement frame 3 taken along the line VII-VII of FIG. 4. The reinforcement frame 3 as shown in the figure has a cross-sectional shape formed in a gate shape providing leg parts with the same length by bending two sides of a plate to the same orientation. The reinforcement frame 3 is attached such that the tips of the two leg parts are in contact with the back face of the backlight chassis 20, and a cavity is provided between the back face thereof and the reinforcement frame 3. The cavity is used as an installation space for the harness 6.

The main substrate 4 includes a control circuit for controlling illumination of the LEDs 23, 23 . . . mounted on the LED substrate 22, and the power supply substrate 5 includes a power supply circuit for the LEDs 23, 23 . . . , and each of the LEDs 23 connected to the main substrate 4 and the power supply substrate 5 via the harness 6 as described above is illuminated by power feeding from the power supply circuit according to a control signal provided from the control circuit.

The liquid crystal display apparatus is configured so as to attach substrate covers 40, 50 and harness covers 60 to the back face of the backlight chassis 20 after making connection of the harness 6 as described above. As shown in FIG. 5, the substrate covers 40, 50 are attached so as to cover the harness 6 guided from the lower portion of the reinforcement frame 3 along with the main substrate 4 and the power supply substrate 5 in order to prevent an imprudent contact with the main substrate 4, the power supply substrate 5 and the harness 6 when used.

On the other hand, the harness cover 60 is attached so as to cover the opening position of the window hole 29 provided at the upper portion of the back face of the backlight chassis along with the harness 6 introduced to the upper portion of the reinforcement frame 3. The harness cover 60 prevents contact from the outside to the harness 6 when used, and also shields an opening of the window hole 29 and prevents external leaking of the illumination of each of the LEDs 23 in the backlight chassis 20.

A liquid crystal control substrate 7 for controlling the liquid crystal panel 1 is also installed on the back face at the lower portion of the backlight chassis 20. The liquid crystal control substrate 7 is arranged between the left-side and right-side reinforcement frames 3, 3, and is covered by a substrate cover 70 extended between the two reinforcement frames 3, 3.

According to the liquid crystal display apparatus configured as above, a back cabinet for covering the entire back face of the backlight chassis 20 is omitted, and the main substrate 4, the power supply substrate 5 and the liquid crystal control substrate 7 attached to the back face are locally covered by the substrate covers 40, 50, 70 separately. Therefore, it is possible to ensure safety by preventing from making contact with the main substrate 4, the power supply substrate 5 and the liquid crystal control substrate 7 when used while reducing manufacturing cost for the simplification of the configuration to meet the demand for miniaturization. The substrate covers 40, 50, 70 can also be configured as one cover member.

The backlight chassis 20 is provided with the window hole 29 so as to correspond to the connector 25 of the inner LED substrate 22, and the harness 6 connected to the connector 25 through the window hole 29 is passed through the inside of the reinforcement frame 3 installed at the back face of the backlight chassis 20 and guided to the installation positions of the main substrate 4 and the power supply substrate 5, and then the harness 6 is connected to these substrates 4, 5. Therefore, the harness 6 is not exposed at the back face of the backlight chassis 20 so that it is possible to prevent from making contact with the harness 6 when used and avoid generation of malfunction due to damage to the harness 6 and disconnection.

Since the harness cover 60 covers between the opening of the window hole 29 and the reinforcement frame 3, the harness 6 between the window hole 29 and the reinforcement frame 3 is not exposed to the outside so that it is possible to prevent generation of malfunction such as damage and disconnection. The window hole 29 is opened to the vicinity of the reinforcement frame 3, therefore, the opening of the window hole 29 can be covered by a small-sized harness cover 60 between the window hole 29 and the reinforcement frame 3. The shape and size of the harness cover 60 are only dependent on the relative positional relation between the window hole 29 and the reinforcement frame 3, and the positional relation between the window hole 29 and the reinforcement frame 3 can be properly configured regardless of the size of the backlight chassis 20. Accordingly, it is possible to use the harness cover 60 universal to liquid crystal display apparatuses of various sizes while suppressing an increase in the number of components at minimum.

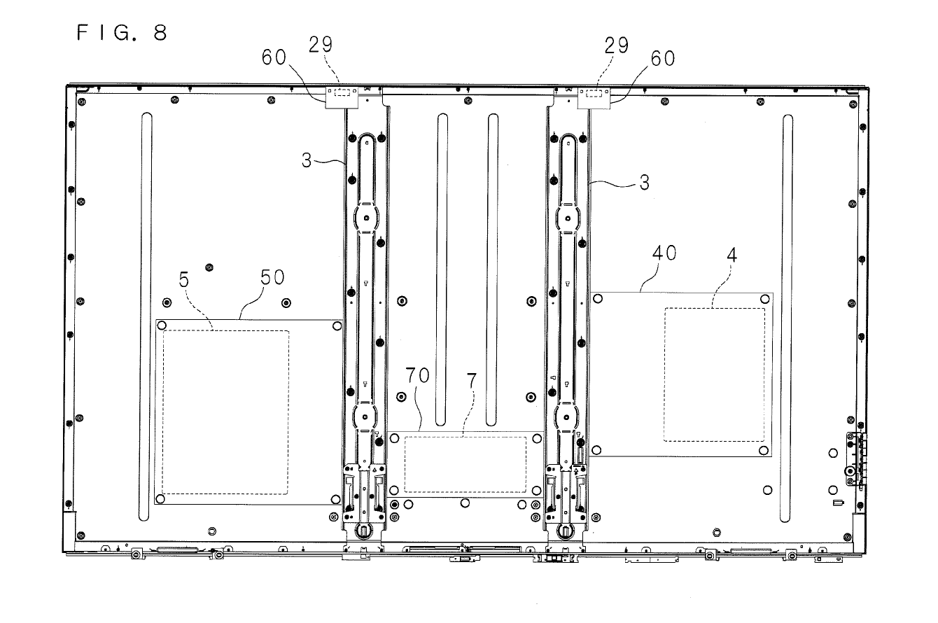

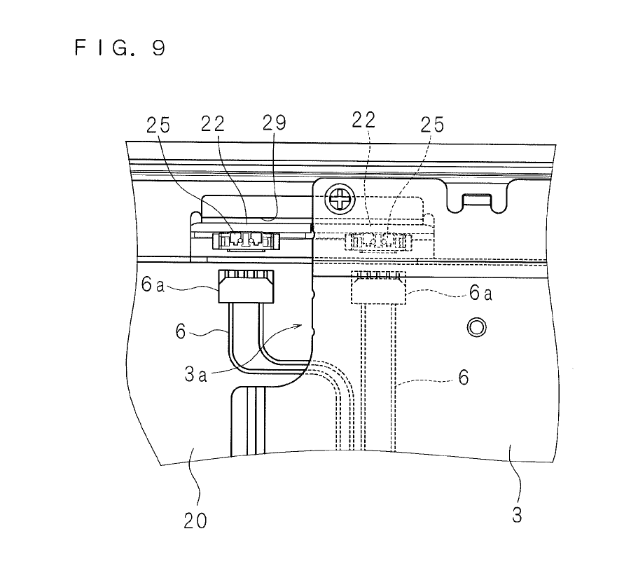

FIG. 8 is a back view of a liquid crystal display apparatus according to Embodiment 2; and FIG. 9 is a plan view that shows the enlargement of a connection part of a harness according to Embodiment 2. According to Embodiment 2, a window hole 29 for wiring connection is formed including one part (a half part) at the inner side of the reinforcement frame 3 as shown in FIG. 9. A window hole 29 at the side opposite (right side) to the one shown in FIG. 9 is also formed including one part (a half part) at the inner side of the reinforcement frame 3 on the right side. According to the configuration, it is possible to further miniaturize the harness covers 60, 60 covering between the window holes 29, 29 and the reinforcement frames 3, 3 as shown in FIG. 8. FIG. 8 shows a state in which the harness covers 60, 60 are attached along with the substrate covers 40, 50, 70, and the window holes 29, 29 are shown by broken lines along with the main substrate 4, the power supply substrate 5 and the liquid crystal control substrate 7.

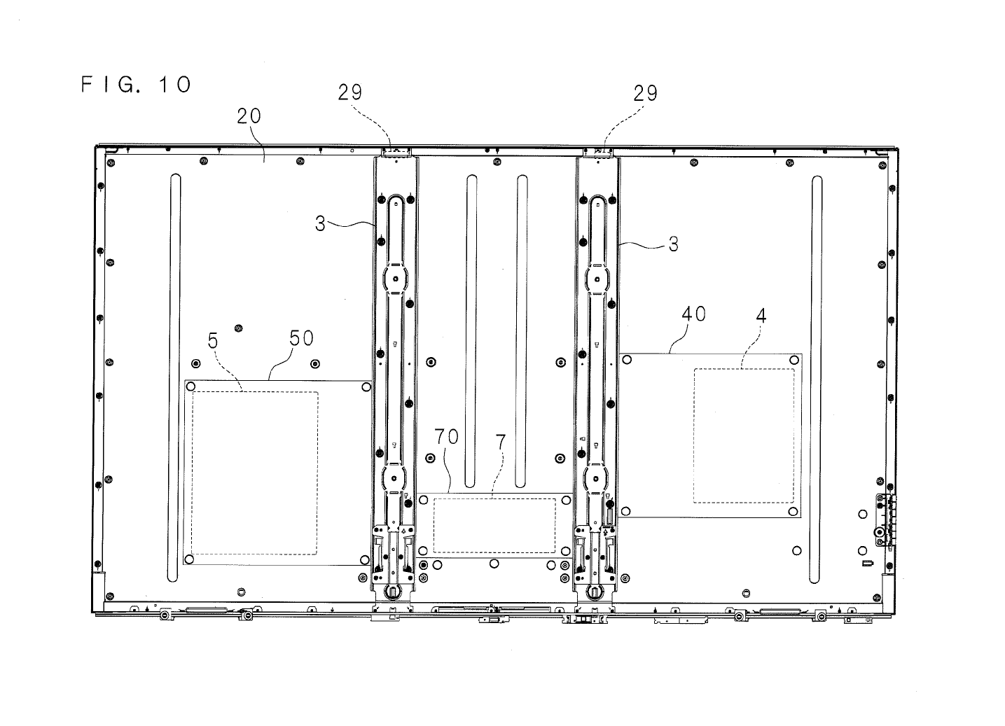

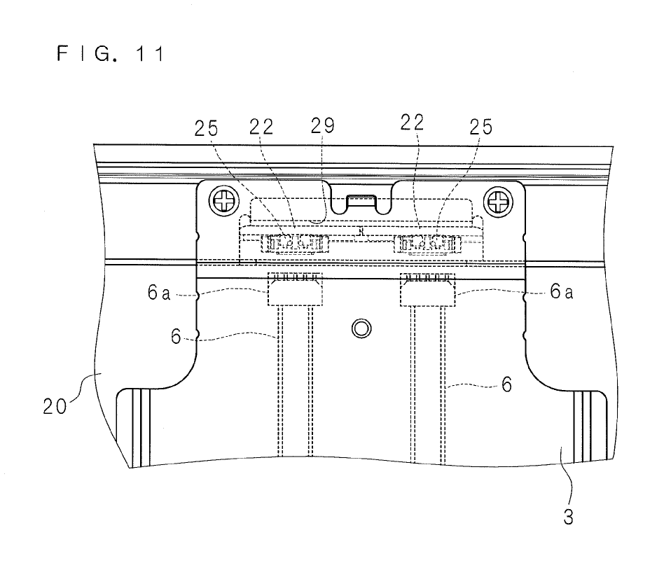

FIG. 10 is a back view of a liquid crystal display apparatus according to Embodiment 3; and FIG. 11 is a plan view that shows the enlargement of a connection part of a harness according to Embodiment 3. According to Embodiment 3, a window hole 29 for wiring connection is all included and formed inside a reinforcement frame 3 as shown in FIG. 11. A window hole 29 disposed at the side opposite (right side) to the one shown in FIG. 11 is similarly opened to the position that is the inner side of the reinforcement frame 3. According to the configuration, harnesses 6, 6 are fitted tightly into the reinforcement frames 3, 3 with connection parts of connectors 25, 25, therefore, it is possible to further simplify the configuration without the need of providing harness covers 60, 60.

In FIG. 11, the window hole 29, the connector 25 and the harness 6 before connection are shown by broken lines, however, the connection between the harness 6 and the connector 25 is carried out before the attachment of the reinforcement frame 3, and then it is possible to realize the configuration of Embodiment 3 by attaching the reinforcement frame 3 subsequently. FIG. 10 shows a state in which the substrate covers 40, 50, 70 are attached, and the window holes 29, 29 disposed inside the reinforcement frames 3, 3 are shown by broken lines along with the main substrate 4, the power supply substrate 5 and the liquid crystal control substrate 7.

The liquid crystal display apparatus described above with a receiving part which receives television broadcasts can be configured as a television receiver for displaying images on the liquid crystal display 1 based on the television broadcasts received by the receiving part. The receiving part can be configured on the main substrate 4 along with a processing part for image signals and audio signals included in the television broadcasts.

### EXPLANATIONS OF REFERENCE NUMERALS

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

1-5. (canceled)

6. A liquid crystal display apparatus in which a backlight unit where a light guide plate and a light source opposite to one side edge of the light guide plate are accommodated in a housing is attached so as to be opposite to the back face of a liquid crystal panel, and in which a light source substrate mounted with the light source and a substrate attached to the back face of the housing are connected by a harness through a window hole opened to the position of the housing, wherein
the window hole is formed at the vicinity of a reinforcement frame installed at the back face of the housing, and the harness is wired through the inside of the reinforcement frame; and
a cover body covers between an opening position of the window hole and the reinforcement frame.

7. The liquid crystal display apparatus according to claim 6, wherein
the window hole is opened including a part inside the reinforcement frame.

8. The liquid crystal display apparatus according to claim 6, wherein
the reinforcement frame has a gate-shaped cross section and is attached such that leg parts on both sides are in contact with the back face of the housing.

9. A liquid crystal display apparatus in which a backlight unit where a light guide plate and a light source opposite to one side edge of the light guide plate are accommodated in a housing is attached so as to be opposite to the back face of a liquid crystal panel, and in which a light source substrate mounted with the light source and a substrate attached to the back face of the housing are connected by a harness through a window hole opened to the position of the housing, wherein
the window hole is formed inside a reinforcement frame installed at the back face of the housing, and the harness is wired through the inside of the reinforcement frame.

10. The liquid crystal display apparatus according to claim 9, wherein
the reinforcement frame has a gate-shaped cross section and is attached such that leg parts on both sides are in contact with the back face of the housing.

11. A television receiver comprising:
the liquid crystal display apparatus according to claim 6; and
a receiving part which receives television broadcasts,
wherein an image is displayed in the liquid crystal display apparatus based on the television broadcasts received by the receiving part.

12. A television receiver comprising:
the liquid crystal display apparatus according to claim 9; and
a receiving part which receives television broadcasts,
wherein an image is displayed in the liquid crystal display apparatus based on the television broadcasts received by the receiving part.
